(19) United States
(12) Patent Application Publication
(10) Pub. No.: US 2019/0331087 A1
(43) Pub. Date: Oct. 31, 2019

(54) VORTEX HYDROTURBINE AND METHOD FOR OPERATING THE VORTEX HYDROTURBINE

(71) Applicant: PETER C. WHITTINGTON, OAKLAND PARK, FL (US)

(72) Inventor: PETER C. WHITTINGTON, OAKLAND PARK, FL (US)

(21) Appl. No.: 15/965,238

(22) Filed: Apr. 27, 2018

(51) Int. Cl. F03B 17/00; F03B 11/02

(52) U.S. Cl. CPC F03B 17/005; F03B 11/02; F05B 2210/11; F05B 2260/406; F05B 2220/32; F05B 2220/706; F05B 2250/232; F05B 2210/40

(57) ABSTRACT

A vortex hydroturbine includes a tank to be filled with a liquid, such as water. At least one turbine circulates the liquid within the tank and produces a vortex. A central turbine is driven by the circulating liquid and an electric generator is driven by the central turbine for producing electricity to be supplied to a load. A method for operating a vortex hydroturbine is also provided.

### BACKGROUND OF THE INVENTION

### Field of the Invention

The present invention relates to an apparatus, in the form of a vortex hydroturbine, for generating electricity. The invention also relates to a method for operating the vortex hydroturbine.

### Description of the Related Art

Cyclonic or anti-cyclonic conversion towers are systems which artificially reproduce confined turbulent fluid flows, called vortices, from an input energy source such as laminar wind flows. Inside the tower different environmental energies can be integrated, that is kinetic wind energy, baric energy due to differences in atmospheric pressure at different levels of the atmosphere, convective thermal energy, and also thermal energy from condensation.

Conventional cyclonic or anti-cyclonic towers are largely made up of a hollow, tubular central conduit or housing, called a vortical duct. The fluid within the central conduit is put into motion forming mini-cyclones or confined turbulent flows call vortices being turbulent flows in a spiraling rotation. Various methods for generating the turbulent flows are known (e.g. wind power). Once the turbulent flow is created (e.g. a swirling wind in a circular body), the kinetic energy of the turbulent flow is converted into mechanical energy which in turn is converted into electricity.

As an example, U.S. Pat. No. 4,070,131 to Yen, teaches an energy generation device where atmospheric wind is admitted into a vertically extending structure and directed against the interior curved surface of a structure for producing a vortex flow of the wind. The vortex flow and corresponding low pressure core draws ambient and/or ram air into the bottom of the structure for driving a horizontal turbine which in turn drives a shaft for driving an electrical generator.

However, the use of wind energy has its drawbacks as it is dependent on the wind and in general the kinetic energy in turbulent wind flows is small compared to that of turbulent liquid flows. A liquid such a water on the other hand, tends to develop greater inertia and causes the turbine to rotate faster and for a longer period of time than air.

### BRIEF SUMMARY OF THE INVENTION

It is accordingly an object of the invention to provide a vortex hydroturbine and a method for operating the vortex hydroturbine, which overcome the hereinafore-mentioned disadvantages of the heretofore-known turbines and methods of this general type and which develop greater inertia causing the turbine to rotate faster and for a longer period of time than the prior art devices.

With the foregoing and other objects in view there is provided, in accordance with the invention, a vortex hydroturbine, comprising a tank to be filled with a liquid, at least one turbine for circulating the liquid within the tank, a central turbine to be driven by the circulating liquid, and an electric generator to be driven by the central turbine for producing electricity.

With the objects of the invention in view, there is also provided a method for operating a vortex hydroturbine, which comprises filling a tank with a liquid, using at least one turbine to circulate the liquid within the tank, using the circulating liquid to drive a central turbine, and using the central turbine to drive an electric generator for producing electricity.

The at least one turbine may be a plurality of turbines creating a vortex in the liquid in the tank. The nature and the density of the liquid, and especially the vortex created in the liquid, creates a great amount of inertia which tends to keep the central turbine rotating.

In accordance with another feature of the invention, the liquid is water supplied to the tank by a reservoir, a vehicle and/or a municipal water supply. The water is fed from the reservoir, vehicle or municipal water supply to the tank through an inlet pipe. If necessary, a pump is provided in the inlet pipe.

In accordance with a further feature of the invention, a shaft interconnects the central turbine and the electric generator. The shaft runs from the bottom of the tank, where the central turbine is located, to the electric generator.

In accordance with an added feature of the invention, a capacitor is charged by the electricity produced by the electric generator. In this way, the capacitor can store the electricity until it is needed to meet the demand.

In accordance with an additional feature of the invention, a crossover switch connects the electric generator to a municipal power line. The crossover switch prevents electricity from the municipal electricity supply from being fed back into the generator.

In accordance with yet another feature of the invention, the tank stands on a cabinet and the electric generator is disposed within the cabinet. This permits the tank to be raised above the ground to provide space for the generator and the capacitor. A collar may be disposed between the cabinet and the tank so as to raise the tank even higher. A ladder may be disposed adjacent the cabinet for providing access to the tank.

In accordance with a concomitant feature of the invention, the tank is frustoconical, the tank has a bottom and a top having a larger diameter than the bottom, and the central turbine is disposed on the bottom. The frustoconical shape of the tank and the location of the central turbine on the bottom facilitate the development of the vortex.

Other features which are considered as characteristic for the invention are set forth in the appended claims.

Although the invention is illustrated and described herein as embodied in a vortex hydroturbine and a method for operating the vortex hydroturbine, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, perspective view of the vortex hydroturbine according to the invention; and

FIG. 2 is a longitudinal-section view of the vortex hydroturbine.

### DETAILED DESCRIPTION OF THE INVENTION

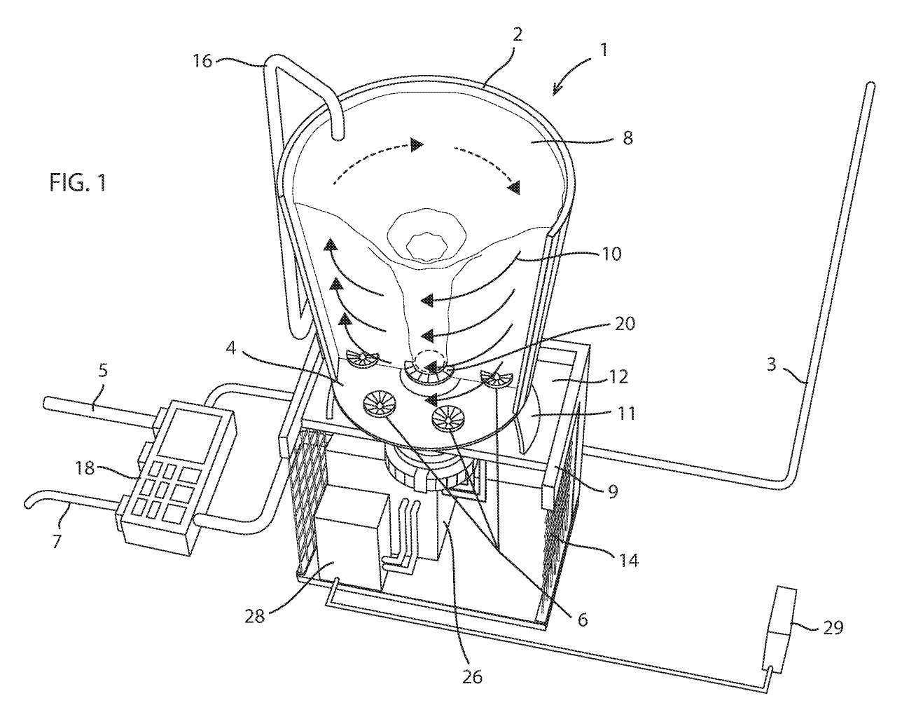

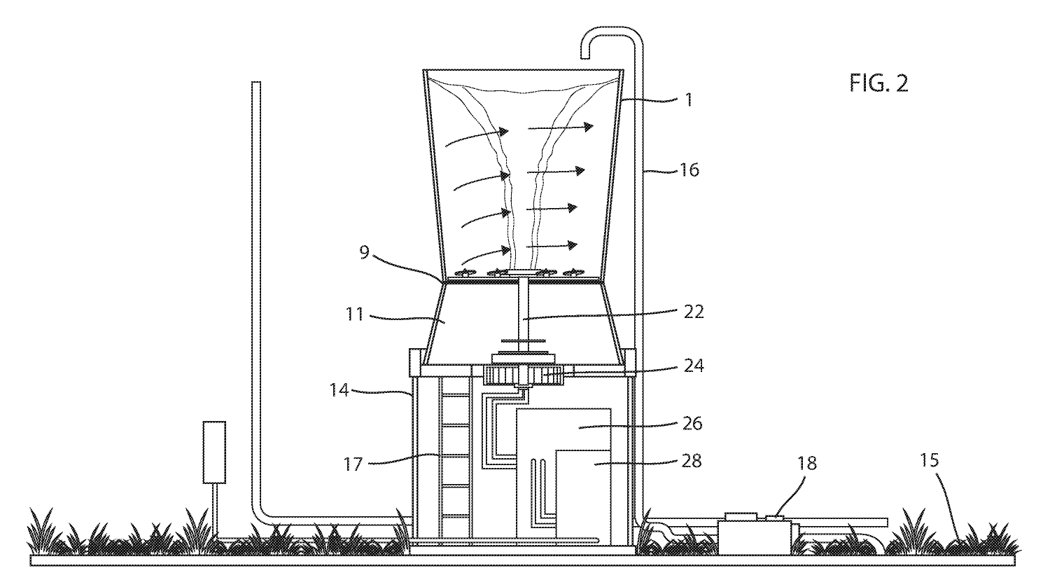

Referring now to the figures of the drawings in detail and first, particularly to FIG. 1 thereof, there is tank 1 having a frustoconical shape in which the wider end of the frustrum of the cone is at the top. The tank has an open top 2 and a closed bottom 4, although the top may be closed by a non-illustrated cover to prevent evaporation. The bottom 4 of the tank 1 rests on the upper surface 9 of a collar 11, which in turn rests within a recess 12 in the upper surface 13 of a machine cabinet 14. A ladder 17 (seen in FIG. 2) permits access to the tank.

A plurality of vortex turbines or fans 6 is located on the bottom 4 of the tank 1. The tank 1 is filled with a liquid 8 which is set in a circular motion indicated by arrows 10 by the force of the turbines 6 creating a vortex in the liquid. The frustoconical shape of the tank and the location of the central turbine on the bottom facilitate the development of the vortex.

The liquid 8 may be water derived from one or more of three possible sources. The first source 3 is water from a roof, a cistern or a reservoir. The second source 5 is water from water trucks brought near the tank. The third source 7 is water from a municipal water supply. If the water source is located at a higher level above the ground than the top 2 of the tank 1, the water will fill the tank by gravity. If the water source is under pressure, it will be fed into the tank by the water pressure. The water from one or more of these three sources is fed to the top of the tank 1 by an inlet pipe 16, which is provided with a pump 18 to be used if gravity or water pressure are not available or insufficient to fill the tank.

The circular motion 10 of the water 8 in the tank 1 turns a central turbine 20 within the tank 1. The central turbine 20 is connected though a shaft 22, which passes through the collar 11, to a generator 24 located in the cabinet 14 that stands on the ground 15, as is best seen in FIG. 2. The generator 24 produces electrical energy which may be stored in a capacitor 26 if the supply of electrical energy exceeds the demand at any given time. The capacitor 26 may be connected directly to a load or consumers or through a generator crossover or transfer switch 28 and through a panel box 29 to the electrical mains or city or municipal power line for providing electrical power to the load or consumers. The load or consumers may be residential or commercial facilities or municipal facilities such as lighting for streets and parks.

1. A vortex hydroturbine, comprising:
a tank to be filled with a liquid;
at least one turbine for circulating the liquid within said tank;
a central turbine to be driven by the circulating liquid; and
an electric generator to be driven by said central turbine for producing electricity.

2. The vortex hydroturbine according to claim 1, wherein the liquid is water supplied to said tank by at least one of a reservoir, a vehicle or a municipal water supply.

3. The vortex hydroturbine according to claim 2, which further comprises an inlet pipe having a pump for feeding the water to said tank.

4. The vortex hydroturbine according to claim 1, wherein said at least one turbine is a plurality of turbines creating a vortex in the liquid in said tank.

5. The vortex hydroturbine according to claim 1, which further comprises a shaft interconnecting said central turbine and said electric generator.

6. The vortex hydroturbine according to claim 1, which further comprises a capacitor to be charged by the electricity produced by said electric generator.

7. The vortex hydroturbine according to claim 1, which further comprises a crossover switch for connecting said electric generator to a municipal power line.

8. The vortex hydroturbine according to claim 1, which further comprises a cabinet on which said tank stands, said electric generator being disposed within said cabinet.

9. The vortex hydroturbine according to claim 8, which further comprises a collar disposed between said cabinet and said tank.

10. The vortex hydroturbine according to claim 9, which further comprises a ladder disposed adjacent said cabinet for providing access to said tank.

11. The vortex hydroturbine according to claim 1, wherein said tank is frustoconical, said tank has a bottom and a top having a larger diameter than said bottom, and said central turbine is disposed on said bottom.

12. A method for operating a vortex hydroturbine, the method comprising the following steps:
filling a tank with a liquid;
using at least one turbine to circulate the liquid within the tank;
using the circulating liquid to drive a central turbine; and
using the central turbine to drive an electric generator for producing electricity.

13. The method according to claim 12, which further comprises providing the tank with a frustoconical shape, a bottom and a top having a larger diameter than the bottom, and placing the central turbine on the bottom to facilitate formation of a vortex in the tank.

14. The method according to claim 12, which further comprises supplying the liquid to the tank in the form of water from at least one of a reservoir, a vehicle or a municipal water supply.

15. The method according to claim 14, which further comprises feeding the water to the tank through an inlet pipe having a pump.

16. The method according to claim 12, which further comprises charging a capacitor with the electricity produced by the electric generator.

17. The method according to claim 12, which further comprises using a crossover switch to connect the electric generator to a municipal power line.
